(19) United States
(12) Patent Application Publication
(10) Pub. No.: US 2026/0152010 A1
(43) Pub. Date: Jun. 4, 2026

(54) PRINTING DEVICE, PRINTING METHOD, AND NON-TRANSITORY COMPUTER READABLE STORAGE MEDIUM

(71) Applicant: BROTHER KOGYO KABUSHIKI KAISHA, Nagoya (JP)

(72) Inventors: Hitomi MIWA, Nagoya (JP); Yuji IIDA, Chita (JP); Shogo MIZUTANI, Nagoya (JP)

(21) Appl. No.: 19/403,430

(22) Filed: Nov. 28, 2025

(30) Foreign Application Priority Data
Nov. 29, 2024 (JP) 2024-209037

(51) Int. Cl. B41J 2/21; B41J 2/045; B41J 3/407; B41J 11/06; B41J 11/14; B41J 29/393; D06P 5/30

(52) U.S. Cl. CPC B41J 2/2128; B41J 2/0457; B41J 2/0458; B41J 2/04581; B41J 2/04593; B41J 3/4078; B41J 11/06; B41J 11/14; B41J 29/393; D06P 5/30

(57) ABSTRACT

A printing device includes an ejection head including nozzles, the nozzles being provided on a nozzle surface of the ejection head and being configured to eject droplets, and a controller. The controller is configured to acquire instruction information indicating on which one of a permeable medium and a non-permeable medium printing is to be performed, the permeable medium being a printing target, the non-permeable medium being a transfer medium to the printing target, in a case where printing is performed on the permeable medium based on the instruction information, cause the nozzles to eject droplets of a first size, and in a case where printing is performed on the non-permeable medium based on the instruction information, cause the nozzles to eject droplets of a second size smaller than the first size.

### REFERENCE TO RELATED APPLICATIONS

This application claims priority from Japanese Patent Application No. 2024-209037 filed on Nov. 29, 2024. The entire content of the priority application is incorporated herein by reference.

### BACKGROUND ART

A related art describes an image forming device including an ejection head that directly ejects ink droplets onto a fabric in the related art.

When printing is performed on a permeable medium such as a fabric, it is conceivable to make an interval between a nozzle surface and the permeable medium large in consideration of, for example, a fact that fluff or the like is contained in the permeable medium. When the amount of ink droplets ejected from the ejection head in a state of the large interval as described above is small, a large amount of mist may be generated. For this reason, it is conceivable to eject a large amount of ink droplets by which mist is less likely to occur.

It is conceivable to print the same image not only on a permeable medium but also on a non-permeable medium such as a film. However, when ejected onto the non-permeable medium, the ink droplets hardly permeate. For this reason, the ink droplets ejected onto the non-permeable medium may hardly spread on the non-permeable medium, and graininess may be noticeable on the non-permeable medium.

An object of the present disclosure is to provide a printing device, a printing method, and a printing program that can make graininess less noticeable on a printed product.

### SUMMARY

A printing device including: an ejection head including nozzles, the nozzles being provided on a nozzle surface of the ejection head and being configured to eject droplets; and a controller, in which the controller is configured to: acquire instruction information indicating on which one of a permeable medium and a non-permeable medium printing is to be performed, the permeable medium being a printing target, the non-permeable medium being a transfer medium to the printing target; in a case where printing is performed on the permeable medium based on the instruction information, cause the nozzles to eject droplets of a first size ; and in a case where printing is performed on the non-permeable medium based on the instruction information, cause the nozzles to eject droplets of a second size smaller than the first size.

### BRIEF DESCRIPTION OF DRAWINGS

FIG. 1 is a plan view showing a configuration of a printing system including a printing device and an image processing device that is an external device according to an embodiment;

FIG. 2 shows nozzles in an ejection head unit in FIG. 1;

FIG. 3 is a block diagram showing a configuration of a control system of the printing system in FIG. 1;

FIG. 4 shows a support position and a printing position that are positions between which a platen moves;

FIG. 5 shows an example of a printing mode designation screen;

FIG. 6A shows a plurality of large ink droplets ejected onto a permeable medium;

FIG. 6B shows a plurality of large ink droplets ejected onto a non-permeable medium;

FIG. 7 shows an example of large ink droplets, medium ink droplets, and small ink droplets ejected onto a non-permeable medium; and

FIG. 8 is a flowchart showing a flow of processing of the printing device.

### DESCRIPTION

Hereinafter, an embodiment of the present disclosure will be described with reference to the drawings. The embodiment described below is merely one embodiment of the present disclosure. Accordingly, the present disclosure is not limited to the following embodiment, and the embodiment can be added, deleted, or modified without departing from the scope of the present disclosure. In the following description, the same or corresponding elements in all the drawings are denoted by the same reference signs, and redundant description thereof is omitted unless otherwise noted.

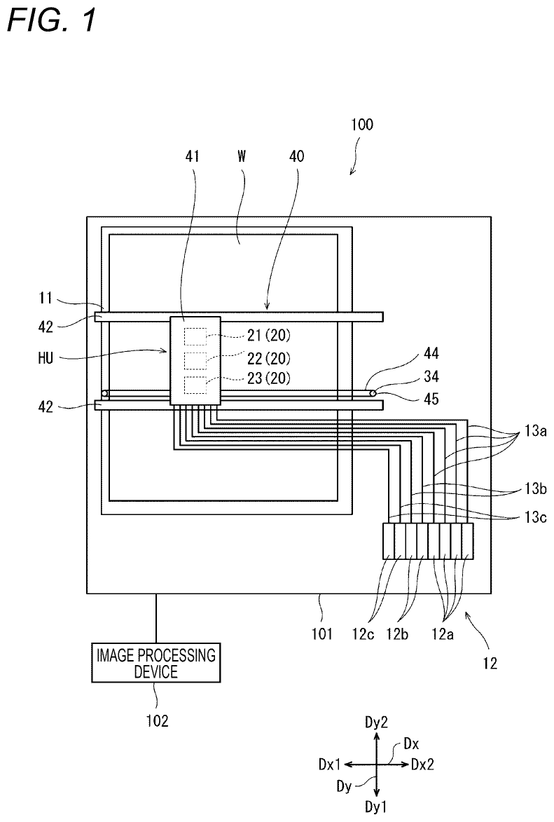

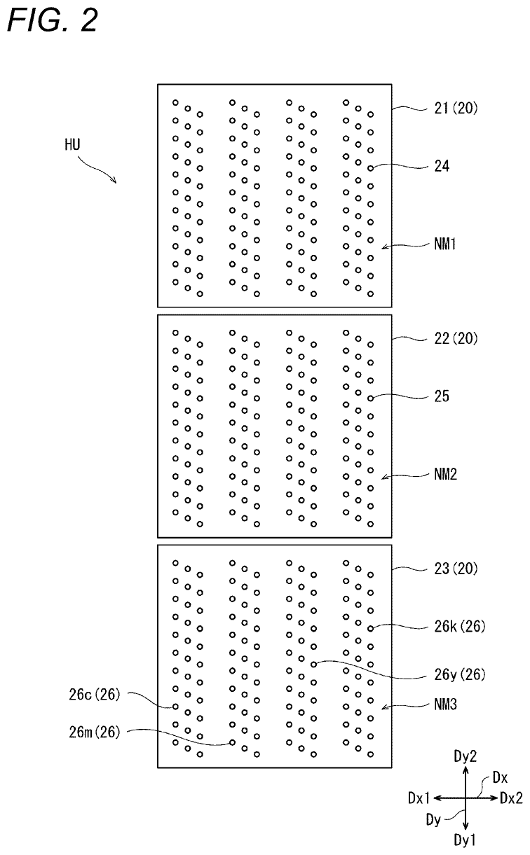

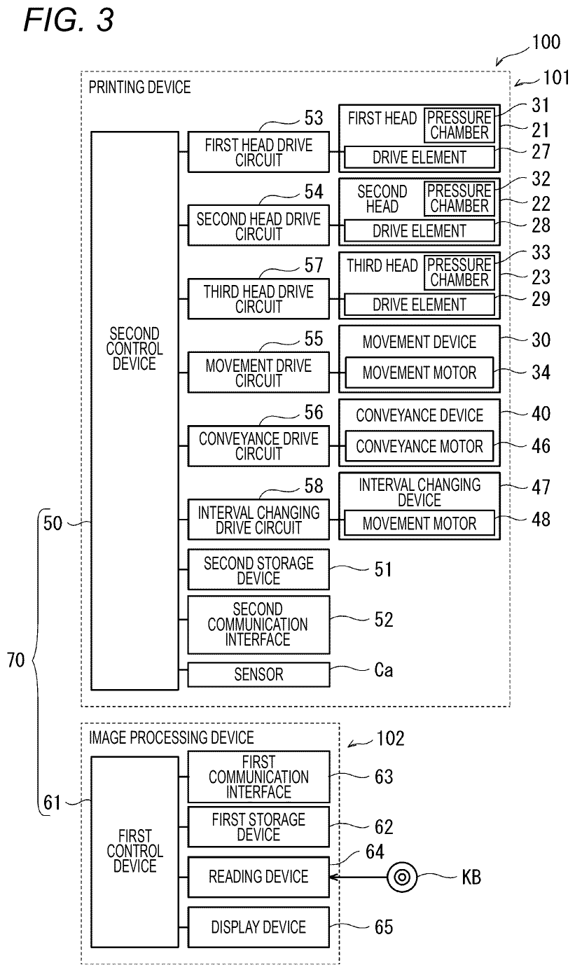

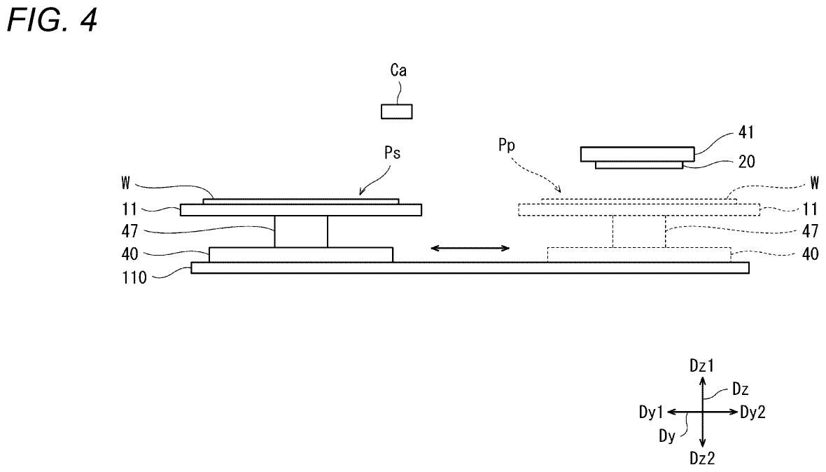

FIG. 1 is a plan view showing a configuration of a printing system 100 including a printing device 101 and an image processing device 102 that is an external device according to an embodiment. FIG. 2 shows nozzles in an ejection head unit HU in FIG. 1. FIG. 3 is a block diagram showing a configuration of a control system of the printing system 100 in FIG. 1. FIG. 4 shows a support position Ps and a printing position Pp that are positions between which a platen 11 moves.

In FIGS. 1 and 2 and the like, directions orthogonal to one another are a first direction Dy, a second direction Dx, and a third direction Dz. In the present embodiment, for example, the first direction Dy is a conveying direction of a printing medium W, the second direction Dx is a moving direction of a carriage 41 described later, and the third direction Dz is an upper-lower direction. In the following description, Dx is referred to as the moving direction, Dy is referred to as the conveying direction, and Dz is referred to as the upper-lower direction. One direction of the conveying direction Dy is Dy1, and the direction opposite to the direction Dy1 is Dy2. The printing medium W is conveyed, for example, in the direction Dy1 during printing. One direction of the moving direction Dx is denoted by Dx1, and the direction opposite to the direction Dx1 is denoted by Dx2. The upward direction of the upper-lower direction Dz is Dz1, and the downward direction is Dz2. However, the above directions are examples and are not limited.

As shown in FIG. 1, the printing system 100 includes the printing device 101 and the image processing device 102. The image processing device 102 corresponds to an external device. The printing device 101 and the image processing device 102 are communicably connected to each other via a wireless or wired manner such as a network. The image processing device 102 is, for example, a personal computer. The image processing device 102 is configured to generate printing data from image data of a printing image, which is an image to be printed on the printing medium W by the printing device 101, and transmit the generated printing data to the printing device 101 in a wireless or wired manner. The printing device 101 is configured to print the printing image on the printing medium W, based on the printing data received from the image processing device 102. Examples of the printing medium W include a fabric, a sheet film, and a roll film.

The printing device 101 is, for example, a serial head type inkjet printer. The printing device 101 is configured to alternately repeat pass processing of ejecting ink droplets while moving an inkjet head 20 in the moving direction Dx and conveying processing of conveying the printing medium W in the conveying direction Dy based on the printing data. Accordingly, a prescribed image is printed on the printing medium W. Hereinafter, the inkjet head 20 is abbreviated as the head 20. The head 20 corresponds to an ejection head.

As shown in FIG. 1, FIG. 3, or FIG. 4, the printing device 101 includes the ejection head unit HU having a plurality of heads 20, the platen 11, a plurality of tanks 12, a movement device 30, a conveyance device 40, an interval changing device 47, and a support plate 110. Hereinafter, components included in the printing device 101 will be described.

The head 20 is configured to print an image on the printing medium W with prescribed ink droplets, based on printing data. A plurality of heads 20 are provided. The plurality of heads 20 are provided as the ejection head unit HU. Examples of the plurality of heads 20 include a first inkjet head 21, a second inkjet head 22, and a third inkjet head 23. Hereinafter, the first inkjet head 21 is abbreviated as the first head 21, the second inkjet head 22 is abbreviated as the second head 22, and the third inkjet head 23 is abbreviated as the third head 23.

The first head 21 is configured to perform printing on the printing medium W with white ink. Accordingly, a base is formed on the printing medium W. The second head 22 is configured to perform printing on the printing medium W with a special ink. The third head 23 is configured to perform printing on the printing medium W with a color ink. Hereinafter, when the head 20 is described, the head 20 includes the first head 21, the second head 22, and the third head 23.

The conveyance device 40 includes, for example, a drive unit including a ball screw or a rack and pinion (not shown), and a conveyance motor 46. The drive unit is coupled to the conveyance motor 46. The platen 11 is configured to reciprocate in the conveying direction Dy by driving of the conveyance motor 46, and convey the printing medium W in the conveying direction Dy. The conveyance device 40 corresponds to a conveying mechanism.

The interval changing device 47 includes, for example, a drive unit including a ball screw or a rack and pinion (not shown), and a movement motor 48. The drive unit is coupled to the movement motor 48. The platen 11 is moved in the upper-lower direction Dz by driving of the movement motor 48. Accordingly, intervals between nozzle surfaces NM1, NM2, NM3 and the platen 11 are changed by the interval changing device 47. The interval changing device 47 corresponds to an interval changing mechanism. The movement of the platen 11 in the conveying direction Dy by the conveyance device 40 and the movement of the platen 11 in the upper-lower direction Dz by the interval changing device 47 will be described later.

The platen 11 has a flat upper surface, and defines a distance between the printing medium W disposed on the upper surface and nozzle surfaces of the head 20 that face the printing medium W. The platen 11 is configured to reciprocate in the conveying direction Dy. Accordingly, the printing medium W supported by the platen 11 reciprocates in the conveying direction Dy. The tanks 12 is configured to store inks therein. The tanks 12 are connected to the head 20 via flow paths described later to supply the inks to the head 20. The number of tanks 12 is equal to or more than the number of types of inks. For example, the tanks 12 include four first tanks 12a configured to store four types of color inks, one or more second tanks 12b configured to store the white ink, and one or more third tanks 12c configured to store the special ink. Examples of the color inks include cyan ink, magenta ink, yellow ink, and black ink. Examples of the special ink include red ink, green ink, and blue ink.

The first tanks 12a communicate with the third head 23 through first flow paths 13a. The color inks are supplied from the first tanks 12a to the third head 23 through the first flow paths 13a. The second tank 12b communicates with the first head 21 through a second flow path 13b. The white ink is supplied from the second tank 12b to the first head 21 through the second flow path 13b. The third tank 12c communicates with the second head 22 through a third flow path 13c. The special ink is supplied from the third tank 12c to the second head 22 through the third flow path 13c.

The movement device 30 includes the carriage 41, two guide rails 42, a movement motor 34, and an endless belt 44. The two guide rails 42 extend in the moving direction Dx above the platen 11 in a manner of sandwiching the carriage 41 in between in the conveying direction Dy. The carriage 41 is configured to hold the head 20. The carriage 41 is supported by the two guide rails 42 to be movable in the direction Dx1 and the direction Dx2 of the moving direction Dx. The endless belt 44 extends in the moving direction Dx, is attached to the carriage 41, and is connected to the movement motor 34 via a pulley 45. In a case where the movement motor 34 starts driving, the endless belt 44 operates and the carriage 41 reciprocates along the guide rails 42 in the moving direction Dx. Accordingly, the head 20 reciprocates in the moving direction Dx by the carriage 41.

Next, as shown in FIG. 2, the first head 21, the second head 22, and the third head 23 are arranged side by side in the conveying direction Dy. The first head 21 includes the nozzle surface NM1, and a plurality of nozzles 24 that are provided on the nozzle surface NM1 and that are configured to eject the white ink onto the printing medium W. The second head 22 includes the nozzle surface NM2, and a plurality of nozzles 25 that are provided on the nozzle surface NM2 and that are configured to eject the special ink onto the printing medium W. The third head 23 includes a nozzle surface NM3, and a plurality of nozzles 26 that are provided on the nozzle surface NM3 and that are configured to eject the color ink onto the printing medium W. The nozzles 26 include a nozzle 26c configured to eject cyan ink, a nozzle 26m configured to eject magenta ink, a nozzle 26y configured to eject yellow ink, and a nozzle 26k configured to eject black ink. The nozzles 25 are disposed between the nozzles 24 and the nozzles 26 in the conveying direction Dy. In the first head 21, the plurality of nozzles 24 constitute a nozzle row along the conveying direction Dy. The same applies to the plurality of nozzles 25 in the second head 22 and the plurality of nozzles 26 in the third head 23. An arrangement of each of the first head 21, the second head 22, and the third head 23 and arrangements of nozzles are examples, and may be appropriately changed.

As shown in FIG. 3, the first head 21 is provided with a drive element 27 and a pressure chamber 31 for each nozzle 24. The second head 22 is provided with a drive element 28 and a pressure chamber 32 for each nozzle 25. The third head 23 is provided with a drive element 29 and a pressure chamber 33 for each nozzle 26. The drive elements 27, 28, 29 are piezoelectric elements, heating elements, and the like. As the drive element 27 starts driving, ejection pressure for ejecting ink droplets from the corresponding nozzle 24 is applied to ink in the pressure chamber 31. The operation of the drive element 28 of the second head 22 and the operation of the drive element 29 of the third head 23 are the same as the operation of the drive element 27 of the first head 21.

In FIG. 3, the printing device 101 includes a second control device 50. The printing device 101 includes a second storage device 51, a second communication interface 52, a first head drive circuit 53, a second head drive circuit 54, a third head drive circuit 57, a movement drive circuit 55, a conveyance drive circuit 56, an interval changing drive circuit 58, and a sensor Ca, which are connected to the second control device 50. The second control device 50 corresponds to a control device, and the second communication interface 52 corresponds to a communication device.

The second storage device 51 is a memory accessible from the second control device 50 and includes, for example, a RAM and a ROM. The RAM is configured to temporarily store printing data and various data during calculation of the second control device 50. The ROM is configured to store various data and a printing program for performing various data processing.

The second control device 50 is implemented by a computer, and includes a processor such as a CPU or an integrated circuit such as an ASIC. The second control device 50 is configured to control operations of components of the printing device 101 by executing the printing program while referring to the data stored in the second storage device 51. The second control device 50 is configured to receive various data such as printing data from the image processing device 102 via the second communication interface 52. A communication standard between the second control device 50 and the second communication interface 52 is Wi-Fi, Ethernet, or the like. The second control device 50 may be configured by a single device, or may be configured such that a plurality of independent devices cooperate to control the operation of the printing device 101. Specifically, the second control device 50 may constitute a control device 70 in cooperation with a first control device 61 of the image processing device 102, and the control device 70 may control the operation of the printing device 101.

The first head drive circuit 53 is configured to control the operation of the drive element 27, based on an instruction from the second control device 50. In this case, the second control device 50 is configured to output a control signal for driving the drive element 27 to the first head drive circuit 53, and the first head drive circuit 53 is configured to generate a drive signal based on the control signal, and output the drive signal to the drive element 27. The drive element 27 is configured to apply prescribed ejection pressure to the white ink in the pressure chamber 31 at prescribed timing based on the drive signal. Accordingly, the white ink is ejected from the nozzle 24. Similar to the first head drive circuit 53, the second head drive circuit 54 is configured to control the operation of the drive element 28 based on an instruction from the second control device 50. Thus, the special ink is ejected from the nozzle 25. Similar to the first head drive circuit 53 and the second head drive circuit 54, the third head drive circuit 57 is configured to control the operation of the drive element 29 based on an instruction from the second control device 50. Thus, the color ink is ejected from the nozzle 26. Hereinafter, it will be described that the second control device 50 applies a drive voltage to each of the drive elements 27, 28, 29 to eject ink droplets.

The movement drive circuit 55 is configured to control the operation of the movement motor 34 included in the movement device 30, based on an instruction from the second control device 50. Accordingly, the carriage 41 reciprocates in the moving direction Dx. Therefore, the first head 21, the second head 22, and the third head 23 reciprocate in the moving direction Dx.

The conveyance drive circuit 56 is configured to control the operation of the conveyance motor 42 of the conveyance device 40 based on an instruction from the second control device 50. Accordingly, the platen 11 intermittently or continuously conveys the printing medium W along the conveying direction Dy, and stops the printing medium W at a prescribed position.

The interval changing drive circuit 58 is configured to control the operation of the movement motor 48 included in the interval changing device 47 based on an instruction from the second control device 50. Accordingly, the platen 11 moves in the upper-lower direction Dz.

Next, the image processing device 102 is a device configured to perform processing on a printing image to be printed by the printing device 101, and is, for example, a personal computer. The image processing device 102 includes the first control device 61 and a first storage device 62, a first communication interface 63, a reading device 64, and a display device 65, which are connected to the first control device 61. The image processing device 102 may be a smartphone, a tablet, or the like.

The first storage device 62 is a memory accessible from the first control device 61 and includes, for example, a RAM and a ROM. The RAM temporarily stores image data and various data during calculation of the first control device 61. The ROM stores various data and a printing program for performing various data processing. Examples of the image data include raster data indicating an image to be printed on the printing medium W.

The first control device 61 is implemented by a computer, and includes a processor such as a CPU or an integrated circuit such as an ASIC. The first control device 61 controls the operation of the printing device 101 and an operation of the display device 65 by executing the printing program while referring to the data stored in the first storage device 62. The first control device 61 transmits various data such as printing data to the printing device 101 via the first communication interface 63. The first control device 61 may be configured by a single device, or may be configured such that a plurality of independent devices cooperate to control the operation of the image processing device 102.

The reading device 64 reads a printing program stored in a storage medium KB such as a CD-ROM or a USB flash memory. The read printing program is stored in the first storage device 62. Alternatively, the printing program may be downloaded via a prescribed communication network and stored in the first storage device 62. The display device 65 is a display and displays a printing image or the like to be printed by the printing device 101 based on image data.

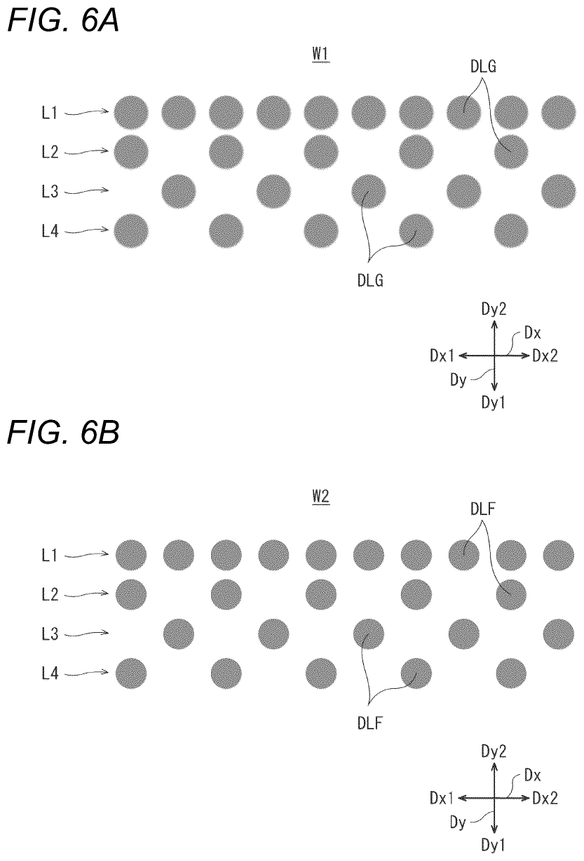

Here, in the present embodiment, as shown in FIGS. 6A and 6B and the like to be described later, a permeable medium W1 or a non-permeable medium W2 is placed on the platen 11 as the printing medium W. Accordingly, the permeable medium W1 or the non-permeable medium W2 is supported by the platen 11. Examples of the permeable medium W1 include cloth, paper, and the like that are printing targets. Examples of the non-permeable medium W2 include a film that is a transfer medium to a printing target. An image printed on the non-permeable medium W2 is transferred to a transfer medium that is a printing target in a thermal transfer device (not shown).

As shown in FIG. 4, the interval changing device 47 is connected to the platen 11. The interval changing device 47 is supported by the conveyance device 40 located below the interval changing device 47. The conveyance device 40 is supported by the support plate 110 to be reciprocally movable in the conveying direction Dy. In such a configuration, the conveyance device 40 is configured to convey the platen 11 from the support position Ps at which the printing medium W, which is the permeable medium W1 or the non-permeable medium W2, is supported on the platen 11 to the printing position Pp at which the permeable medium W1 or the non-permeable medium W2 supported on the platen 11 faces the head 20. Accordingly, the permeable medium W1 or the non-permeable medium W2 on the platen 11 moves between the support position Ps and the printing position Pp. The support position Ps is a position where the printing medium W is placed on the platen 11. As will be described later, when printing control is executed by the second control device 50, the permeable medium W1 or the non-permeable medium W2 starts to be conveyed from the support position Ps toward the printing position Pp.

The second control device 50 is configured to acquire position information indicating a height position of the permeable medium W1 or the non-permeable medium W2 supported by the platen 11, during the conveyance of the platen 11 from the support position Ps to the printing position Pp. In this case, the sensor Ca is configured to detect the height position of the permeable medium W1 or the non-permeable medium W2, and transmit a detection result to the second control device 50. The sensor Ca may be any sensor that can detect a height position of a detection target, and an example thereof includes a laser displacement sensor. The second control device 50 acquires the position information indicating the height position of the permeable medium W1 or the non-permeable medium W2 during the conveyance of the platen 11 from the support position Ps to the printing position Pp, but the present disclosure is not limited thereto. The position information indicating the height position of the permeable medium W1 or the non-permeable medium W2 may be acquired while the permeable medium W1 or the non-permeable medium W2 is conveyed to a position below the sensor Ca by the platen 11 and then moved in the upward direction Dz1.

Here, in a case where printing is performed on the permeable medium W1 and the height position acquired by the sensor Ca during the conveyance is equal to or higher than a prescribed reference position, the second control device 50 causes the interval changing device 47 to lower the platen 11 to continue the conveyance such that the height position is lower than the reference position. In this regard, when printing is performed on the permeable medium W1 and an interval between the permeable medium W1 and the nozzle surfaces NM1, NM2, NM3 increases, landing accuracy of ink droplets may decrease and image quality may decrease. However, since the ink droplets have good permeability, the landing accuracy would not be greatly affected even when the ink droplets are ejected in a state where the interval increases. Accordingly, the conveyance can be continued. On the other hand, in a case where printing is performed on the non-permeable medium W2 and the height position acquired by the sensor Ca during the conveyance is equal to or higher than the reference position, the second control device 50 controls the conveyance device 40 to move the platen 11 moving from the support position Ps toward the printing position Pp to the support position Ps. Accordingly, a user can reset the non-permeable medium W2 on the platen 11. In this regard, when printing is performed on the non-permeable medium W2, since the permeability of the ink droplets is not good, the landing accuracy would be greatly affected when the ink droplets are ejected in a state where the interval is increased. For this reason, the platen 11 is moved to the support position Ps without continuing the conveyance.

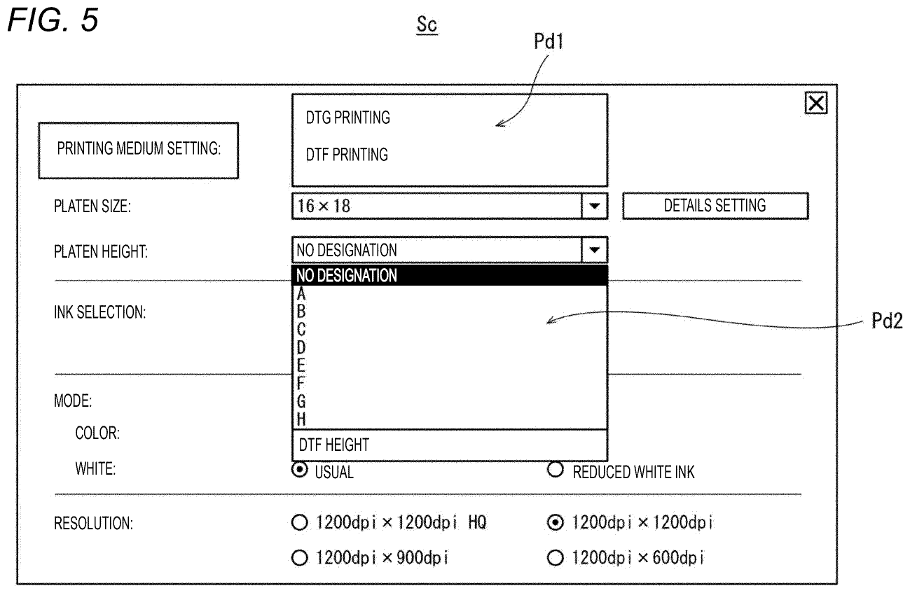

FIG. 5 shows an example of a printing mode designation screen Sc. The designation screen Sc is displayed on the display device 65 of the image processing device 102. As shown in FIG. 5, the designation screen Sc has a designation part Pd1 and a designation part Pd2. In the designation part Pd1, the user can select one of “direct to garment (DTG) printing” and “direct to film (DTF) printing”. The user can select “DTG printing” in the designation part Pd1 when desiring to print on the permeable medium W1, and can select “DTF printing” in the designation part Pd1 when desiring to print on the non-permeable medium W2. When “DTG printing” is selected, the user can select, for example, any one of “A” to “H” which are prescribed values of a platen height. On the other hand, when “DTF printing” is selected, for example, the user cannot select the platen height, and the platen height is determined as “DTF height” for “DTF printing”. In the present embodiment, “DTF height”, which is the platen height, is set to be higher than platen heights other than “DTF height”. For this reason, when the DTF printing is executed, the interval between the nozzle surfaces NM1, NM2, NM3 and the platen 11 is smaller than that when the DTG printing is executed.

The first control device 61 of the image processing device 102 is configured to transmit information indicating which one of “DTG printing” and “DTF printing” is to be executed, that is, information indicating which one of the permeable medium W1 and the non-permeable medium W2 is to be used for printing, to the printing device 101 via the first communication interface 63 as instruction information. Together with the instruction information, the first control device 61 is further configured to transmit information on a determined platen height to the printing device 101 via the first communication interface 63.

The second control device 50 of the printing device 101 is configured to acquire the instruction information and the information on the platen height received from the image processing device 102 via the second communication interface 52. Then, the second control device 50 is configured to cause the interval changing device 47 to move the platen 11 in the upper-lower direction Dz based on the acquired information on the platen height, and execute processing described later based on the acquired instruction information.

Here, graininess due to ejected ink droplets will be described. FIG. 6A shows a plurality of large ink droplets DLG ejected onto the permeable medium W1, and FIG. 6B shows a plurality of large ink droplets DLF ejected onto the non-permeable medium W2. In FIGS. 6A and 6B, printing densities on lines L2, L3, L4 along the moving direction Dx are lower than the printing density on the line L1. In the present embodiment, the printing density is a ratio of an area of ink droplets per unit area. Therefore, when the printing density is low, the ratio of the area of the ink droplets per unit area is relatively small, and when the printing density is high, the ratio of the area of the ink droplets per unit area is relatively large.

As shown in FIG. 6A, for example, in a case where the large ink droplets DLG are ejected onto the permeable medium W1, the ink droplets DLG easily permeate the permeable medium W1. For this reason, a dot diameter increases due to the permeation after the ink droplets DLG permeate the permeable medium W1. In contrast, as shown in FIG. 6B, for example, in a case where the large ink droplets DLF are ejected onto the non-permeable medium W2, the ink droplets DLF hardly permeate into the non-permeable medium W2. For this reason, the dot diameter of the ink droplets DLF hardly increases.

In this manner, since the ink droplets DLG ejected onto the permeable medium W1 permeate the permeable medium W1 and have an increased diameter, the graininess is relatively less noticeable particularly on the lines L2, L3, L4. On the other hand, since the ink droplets DLF ejected onto the non-permeable medium W2 hardly permeate into the non-permeable medium W2, the graininess is relatively more noticeable particularly on the lines L2, L3, L4.

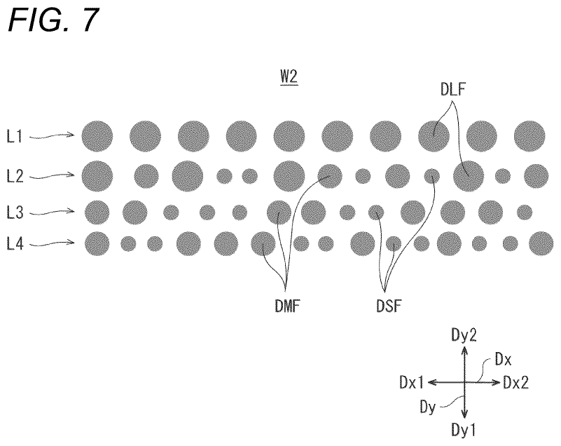

FIG. 7 shows an example of the large ink droplets DLF, medium ink droplets DMF, and small ink droplets DSF ejected onto the non-permeable medium W2.

First, the second control device 50 is configured to cause the interval changing device 47 to change the interval between the nozzle surfaces NM1, NM2, NM3 and the platen 11, before executing the ink droplet ejection processing based on the acquired instruction information. In this case, in a case where the DTF printing is performed, that is, in a case where printing is performed on the non-permeable medium W2, the second control device 50 is configured to cause the interval changing device 47 to change the interval such that the interval between the nozzle surfaces NM1, NM2, NM3 and the platen 11 is smaller than that when the DTG printing is performed, that is, in a case where printing is performed on the permeable medium W1. Specifically, in a case where the DTF printing is selected by the user, the second control device 50 moves the platen 11 in the upper-lower direction Dz by the interval changing device 47 such that the height of the platen 11 becomes “DTF height”. On the other hand, in a case where the DTG printing is selected by the user, the second control device 50 moves the platen 11 in the upper-lower direction Dz by the interval changing device 47 such that the height of the platen 11 becomes a platen height selected by the user. After moving the platen 11 in this way, the second control device 50 executes the following processing based on the instruction information.

In a case where performing printing on the permeable medium W1 based on the instruction information, the second control device 50 executes, for example, processing of ejecting the extra-large ink droplets DLG from the nozzles 24, 25, 26. On the other hand, in a case where the second control device 50 performs printing on the non-permeable medium W2 based on the instruction information, examples of the ejection processing include following first to fourth ejection modes.

### First Ejection Mode

In the first ejection mode, in a case where printing is performed on the permeable medium W1, the second control device 50 is configured to cause the nozzle to eject, for example, the large ink droplets DLG. For example, when ejecting the ink droplets DLF, the second control device 50 is configured to apply a higher voltage to the drive elements 27, 28, 29 than when ejecting the ink droplets DLG. In the first ejection mode, the ink droplets DLG correspond to droplets of a first size.

In contrast, when printing is performed on the non-permeable medium W2, as shown in FIG. 7, the second control device 50 is configured to cause the nozzle to eject the large ink droplets DLF, the medium ink droplets DMF, and the small ink droplets DSF. In the first ejection mode, the ink droplets DMF and the ink droplets DSF correspond to droplets of a second size smaller than the first size, and the ink droplets DLF correspond to droplets of a third size larger than the first size. Therefore, the size of the ink droplets DLF is larger than the size of the ink droplets DLG. In this case, for example, the ink droplets DLF may be fairly large droplets.

Here, a part defined by the ink droplets DMF and DSF is thinner than a part formed by the ink droplets DLF due to a fact that the printing target is the non-permeable medium W2 into which the ink droplets hardly permeate. For this reason, banding, which is a band shape of printing, is more noticeable. Therefore, as shown in FIG. 7, the second control device 50 is configured to cause the nozzle to eject the ink droplets DLF larger than the ink droplets DLG. At the same time, the second control device 50 is configured to cause the nozzle to eject at least one of the ink droplets DMF and the ink droplets DSF. Therefore, thinning can be restricted in each line, and thus banding can be restricted.

In FIG. 7, for comparison with the lines L2, L3, L4, the line L1 on the non-permeable medium W2 shows a mode in which the ink droplets DLF are ejected at substantially equal intervals in an extending direction of the line L1.

In contrast, the line L2 shows a mode in which the ink droplets DMF and DSF are ejected in addition to the ink droplets DLF. Specifically, the ink droplets DLF on the line L2 are ejected onto the same positions as and different positions from positions of the ink droplets DLF on the line L1 in the moving direction Dx. On the line L2, the ink droplets DMF and DSF are ejected at the same positions as positions of the ink droplets DLF ejected on the line L1 in the moving direction Dx. On the line L2, the ink droplets DMF and DSF are ejected at positions between one ink droplet DLF and another ink droplet DLF adjacent thereto in the moving direction Dx on the line L1. The same positions mean that positions of at least a part of the ink droplets DMF and DSF on the line L2 in the moving direction Dx are the same as the positions of the ink droplets DLF on the line L1 in the moving direction Dx. The same positions apply to the following description.

The line L3 shows a mode that the ink droplets DMF and DSF are ejected instead of the ink droplets DLF. Specifically, similar to the line L2, on the line L3, the ink droplets DMF and DSF are ejected at the same positions as the positions of the ink droplets DLF ejected on the line L1 in the moving direction Dx. Similar to the line L2, on the line L3, the ink droplets DMF and DSF are ejected at positions between one ink droplet DLF and another ink droplet DLF adjacent thereto in the moving direction Dx on the line L1.

Similar to the line L3, the line L4 shows a mode in which the ink droplets DMF and DSF are ejected instead of the ink droplets DLF. Specifically, similar to the line L3, on the line L4, the ink droplets DMF and DSF are ejected at the same positions as the positions of the ink droplets DLF ejected on the line L1 in the moving direction Dx. Similar to the line L3, on the line L4, the ink droplets DMF and DSF are ejected at positions between one ink droplet DLF and another ink droplet DLF adjacent thereto in the moving direction Dx on the line L1.

Arrangements of the ink droplets DMF and DSF on the lines L2, L3, L4 are not limited to the example in FIG. 7. That is, the present disclosure is not limited to the example in FIG. 7 as long as a requirement that the ink droplets DMF and DSF are ejected at the same positions in the moving direction Dx as the positions of the ink droplets DLF ejected on the line L1 or at positions between one ink droplet DLF and another ink droplet DLF adjacent thereto in the moving direction Dx on the line L1 is satisfied.

In this manner, according to the first ejection mode, when printing is performed on the non-permeable medium W2, the size of the ink droplets DMF and the size of the ink droplets DSF are smaller than the size of the ink droplets DLG. Accordingly, visibility on the non-permeable medium W2 is reduced, and thus the graininess is less noticeable.

According to the first ejection mode, the size of the ink droplets DLF is larger than the size of the ink droplets DMF and the size of the ink droplets DSF. Accordingly, compared with a case where only the ink droplets DMF and the ink droplets DSF are ejected, the banding, which is a band shape of printing, is restricted, and the graininess is less noticeable.

According to the first ejection mode, both the ink droplets DMF and the ink droplets DSF are ejected as ink droplets having a plurality of different sizes, and thus the graininess is less noticeable. In addition, since a high printing density is easily obtained, the number of printing passes is reduced, and thus productivity can be improved.

According to the first ejection mode, the size of the ink droplets DLF is larger than the size of the ink droplets DLG, and thus the banding can be further restricted.

According to the first ejection mode, when the ink droplets DLF are ejected, a voltage higher than that when the ink droplets DLG are ejected is applied to the drive elements 27, 28, 29. Accordingly, a method of ejecting the ink droplets DLF of the third size is easier than that when the ink droplets DLF are ejected by a method in which the applied voltage is not changed, such as a method in which a supplier or a consumer of the printing device changes an ejection waveform for ejecting the ink droplets DLG to eject the ink droplets DLF.

In the first ejection mode, at least one of the ink droplets DMF and the ink droplets DSF may be ejected.

### Second Ejection Mode

In the first ejection mode described above, the ink droplets DLF are ejected on the non-permeable medium W2, and the ink droplets DLF may not be ejected. In the second ejection mode, the ink droplets DLG correspond to droplets of the first size, and the ink droplets DMF and the ink droplets DSF correspond to droplets of the second size smaller than the first size.

In the second ejection mode, at least one of the ink droplets DMF and the ink droplets DSF may be ejected.

### Third Ejection Mode

In the first ejection mode described above, the ink droplets DMF and the ink droplets DSF are ejected, and the ink droplets DLF larger than the size of the ink droplets DLG are also ejected, but the present disclosure is not limited thereto. In the third ejection mode, the ink droplets DMF and the ink droplets DSF are ejected, and the ink droplets DLF smaller than the size of the ink droplets DLG may be ejected. In the third ejection mode, the ink droplets DLG correspond to the droplets of the first size, the ink droplets DMF and the ink droplets DSF correspond to the droplets of the second size, and the ink droplets DLF correspond to the droplets of the third size. In this case, for example, the ink droplets DLG may be fairly large droplets, and the ink droplets DLF may be large droplets.

In this manner, according to the third ejection mode, since the ink droplets DLF having a size smaller than the size of the ink droplets DLG are ejected, bleeding of the ink droplets on the non-permeable medium W2 can be restricted.

### Fourth Ejection Mode

In the first ejection mode described above, when the ink droplets DLF are ejected, a voltage higher than that when the ink droplets DLG are ejected is applied to the drive elements 27, 28, 29, but the present disclosure is not limited thereto. In the fourth ejection mode, the ink droplets DLF may be formed based on an ejection waveform different from an ejection waveform for forming the ink droplets DLG.

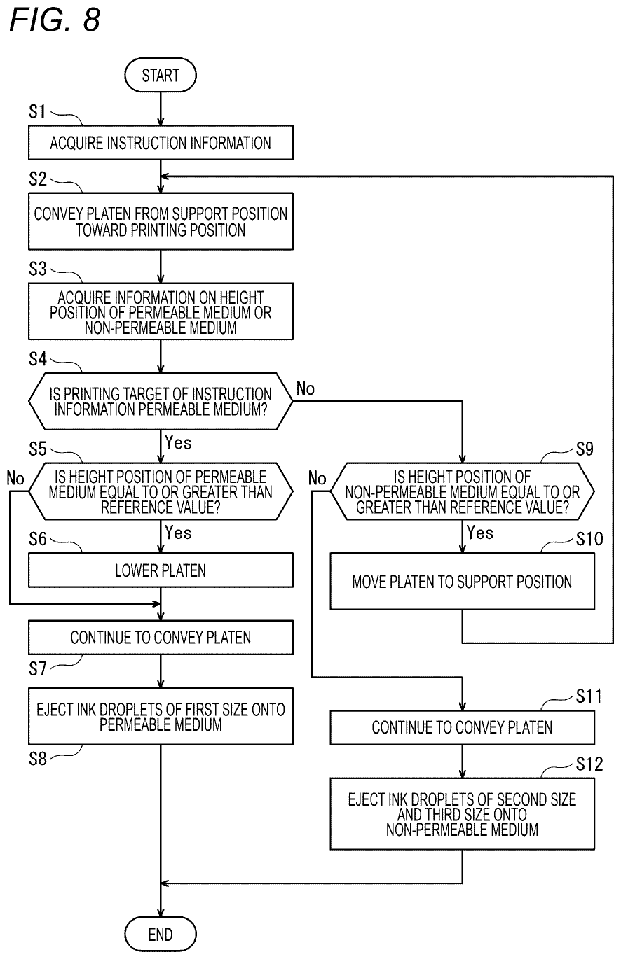

FIG. 8 is a flowchart showing a flow of processing of the printing device 101. As shown in FIG. 8, the second control device 50 acquires the above-described instruction information (step S1). The second control device 50 changes a height of the platen 11 to the platen height designated on the designation screen. Next, the second control device 50 conveys the platen 11 from the support position Ps toward the printing position Pp (step S2).

Subsequently, the second control device 50 acquires position information indicating the height position of the permeable medium W1 or the non-permeable medium W2 from the sensor Ca (step S3). Then, the second control device 50 determines whether the printing target indicated by the instruction information is the permeable medium W1 from, for example, the information of “direct to garment (DTG) printing” and “direct to film (DTF) printing” selected in the designation part Pd1 (step S4). When the printing target is the permeable medium W1 (Yes in step S4), the second control device 50 determines whether the height position of the permeable medium W1 is equal to or greater than a reference value (step S5).

In a case where the height position of the permeable medium W1 is equal to or greater than the reference value (Yes in step S5), the second control device 50 causes the interval changing device 47 to lower the platen 11 such that the height position is lower than the reference position (step S6), and continues to convey the platen 11 (step S7). On the other hand, in a case where the height position of the permeable medium W1 is not equal to or greater than the reference value (No in step S5), the second control device 50 continues to convey the platen 11 (step S7). Then, the second control device 50 executes ejection processing of ejecting the ink droplets DLG as the ink droplets of the first size onto the permeable medium W1 (step S8).

On the other hand, in a case where the printing target is not the permeable medium W1, that is, in a case where the printing target is the non-permeable medium W2 (No in step S4), the second control device 50 determines whether the height position of the non-permeable medium W2 is equal to or greater than the reference value (step S9).

In a case where the height position of the non-permeable medium W2 is equal to or greater than the reference value (Yes in step S9), the second control device 50 moves the platen 11 to the support position Ps (step S10). Then, after the user resets the non-permeable medium W2 on the platen 11 again, and the second control device 50 returns to the processing of step S2 described above and repeats the subsequent processing.

On the other hand, in a case where the height position of the non-permeable medium W2 is not equal to or greater than the reference value (No in step S9), the second control device 50 continues to convey the platen 11 (step S11). Then, the second control device 50 executes ejection processing of ejecting, for example, the ink droplets DMF and DSF as the ink droplets of the second size and ejecting the ink droplets DLF as the ink droplets of the third size onto the non-permeable medium W2 (step S12). When an infrared sensor or the like is used as the sensor Ca, S3 is omitted, and it is determined in S5 and S9 whether a signal from the infrared sensor is received. When it is determined that the second control device 50 received the notification, S6 and S10 are executed.

In the present embodiment, when printing is performed on the non-permeable medium W2, the interval between the nozzle surfaces NM1, NM2, NM3 and the platen 11 is changed by the interval changing device 47 to be smaller than when printing is performed on the permeable medium W1. Accordingly, landing accuracy of the ink droplets is improved, and thus the printing quality is improved.

Further, in the present embodiment, when printing is performed on the non-permeable medium W2, for example, when the non-permeable medium W2 is supported by the platen 11 in an inclined state and only a height position of a part of the non-permeable medium W2 is equal to or higher than the reference position, the platen 11 is not lowered by the interval changing device 47. This is to avoid an increase in the interval between the nozzle surfaces NM1, NM2, NM3 and a remaining part of the non-permeable medium W2 excluding the above-described part when the platen 11 supporting the non-permeable medium W2 in the inclined state is lowered. When the interval between the remaining part and the nozzle surfaces NM1, NM2, NM3 is increased as described above, a landing position deviation may be more noticeable than a case of the permeable medium W1 due to a fact that the ejected ink droplets hardly spread on the non-permeable medium W2. Therefore, in the present embodiment, when printing is performed on the non-permeable medium W2 and the height position is equal to or higher than the reference position, the platen 11 is moved to the support position Ps without being lowered. Accordingly, the user can reset the non-permeable medium W2 on the platen 11 such that the non-permeable medium W2 takes an appropriate posture. On the other hand, when printing is performed on the permeable medium W1 and the height position is equal to or higher than the prescribed reference position, the platen 11 is lowered by the interval changing device 47. For this reason, a probability that the permeable medium W1 comes into contact with the nozzle surfaces NM1, NM2, NM3 can be reduced.

Further, in the present embodiment, the user can transmit the above-described instruction information from an application in the image processing device 102 or the like, which is an example of an external device. Therefore, the instruction information can be easily transmitted.

The present disclosure is not limited to the above-described embodiment, and following modifications can be adopted without departing from the gist of the present disclosure.

In the above embodiment, when printing is performed on the permeable medium W1, medium droplets and small droplets may be ejected together with the large ink droplets DLG.

In the above embodiment, the present disclosure may not be applied when the white ink is ejected onto the permeable medium W1 and the non-permeable medium W2 to form the base. Similarly, the present disclosure may not be applied when the color ink is ejected onto the permeable medium W1 and the non-permeable medium W2.

In the above-described embodiment, when the interval between the nozzle surfaces NM1, NM2, NM3 and the platen 11 is changed, the platen 11 is moved in the upper-lower direction Dz by the interval changing device 47. Alternatively, the present disclosure is not limited thereto. The head 20 may be moved in the upper-lower direction Dz by an interval changing device. Alternatively, the head 20 may be moved in the upper-lower direction Dz by an interval changing device, and the platen 11 may be moved in the upper-lower direction Dz by another interval changing device.

In the above-described embodiment, the second control device 50 may acquire instruction information regarding whether the printing medium W is the permeable medium W1 or the non-permeable medium W2 by the user inputting the instruction information in advance in the printing system 100. Alternatively, an imaging device provided in the printing system 100 may take an image of the printing medium W before printing, and the second control device 50 may acquire an imaging result from the imaging device as the instruction information.

The above-described embodiment described a mode in which the platen 11 that supports the printing medium W reciprocates in the conveying direction Dy to convey the printing medium W in the conveying direction Dy, but the present disclosure is not limited thereto. A roll-shaped transfer film serving as the printing medium W may be conveyed on a platen by a conveyance roller. According to this mode, an image printed on the printing medium W is transferred to a transfer medium by a thermal transfer device. In the present mode, when the processing of changing the interval between the nozzle surfaces of the ejection head and the platen is executed, the ejection head may be moved up and down, the platen may be moved up and down, or both the ejection head and the platen may be moved up and down.

The embodiment described above adopted a configuration in which the first head 21, the second head 22, and the third head 23 are provided as the plurality of heads 20, but the present disclosure is not limited thereto. In the printing device 101 according to the above embodiment, at least the third head 23 may be provided.

What is claimed is

1. A printing device comprising:
an ejection head including nozzles, the nozzles being provided on a nozzle surface of the ejection head and being configured to eject droplets; and
a controller,
wherein the controller is configured to:
acquire instruction information indicating on which one of a permeable medium and a non-permeable medium printing is to be performed, the permeable medium being a printing target, the non-permeable medium being a transfer medium to the printing target;
in a case where printing is performed on the permeable medium based on the instruction information, cause the nozzles to eject droplets of a first size ; and
in a case where printing is performed on the non-permeable medium based on the instruction information, cause the nozzles to eject droplets of a second size smaller than the first size.

2. The printing device according to claim 1,
wherein in a case where printing is performed on the non-permeable medium, the controller is configured to cause the nozzles to eject the droplets of the second size and droplets of a third size larger than the second size.

3. The printing device according to claim 1,
wherein the second size includes a plurality of different sizes, and
in a case where printing is performed on the non-permeable medium, the controller is configured to cause the nozzles to eject droplets of the plurality of sizes as the second size.

4. The printing device according to claim 1,
wherein in a case where printing is performed on the non-permeable medium, the controller is configured to cause the nozzles to eject droplets of a third size larger than the first size.

5. The printing device according to claim 4,
wherein the ejection head includes:
a pressure chamber provided for each of the nozzles; and
a drive element configured to apply ejection pressure to the pressure chamber, and
in a case where the controller cause the nozzles to eject the droplets of the third size, the controller applies, to the drive element, a voltage higher than a voltage applied in a case where the controller cause the nozzles to eject the droplets of the first size.

6. The printing device according to claim 1,
wherein in a case where printing is performed on the non-permeable medium, the controller is configured to cause the nozzles to eject the droplets of the second size and droplets of a third size larger than the second size and smaller than the first size.

7. The printing device according to claim 1, further comprising:
a platen on which the permeable medium or the non-permeable medium is to be placed; and
an interval changing mechanism configured to change an interval between the nozzles surface and the platen,
wherein the controller is configured to cause the interval changing mechanism to change the interval such that the interval is smaller in a case where printing is performed on the non-permeable medium than in a case where printing is performed on the permeable medium.

8. The printing device according to claim 1, further comprising:
a platen on which the permeable medium or the non-permeable medium is to be placed;
an interval changing mechanism configured to change an interval between the nozzle surface and the platen; and
a conveying mechanism configured to convey the platen, from a support position at which the permeable medium or the non-permeable medium is supported on the platen, to a printing position at which the permeable medium or the non-permeable medium supported on the platen faces the ejection head,
wherein the controller is configured to:
acquire position information indicating a height position of the permeable medium or the non-permeable medium supported by the platen, during conveyance from the support position to the printing position,
in a case where printing is performed on the permeable medium and the height position acquired during the conveyance is equal to or higher than a prescribed reference position, cause the interval changing mechanism to lower the platen such that the height position is lower than the reference position, to continue the conveyance, and
in a case where printing is performed on the non-permeable medium and the height position acquired during the convey is equal to or higher than the reference position, cause the conveying mechanism to move the platen to the support position.

9. The printing device according to claim 1, further comprising:
a communication device configured to communicate with an external device,
wherein the controller is configured to acquire the instruction information transmitted from the external device, via the communication device.

10. A printing method comprising:
acquiring instruction information indicating on which one of a permeable medium and a non-permeable medium printing is to be performed, the permeable medium being a printing target, the non-permeable medium being a transfer medium to the printing target;
in a case where printing is performed on the permeable medium based on the instruction information, ejecting droplets of a first size from the nozzles, the nozzles being provided on a nozzle surface of an ejection head; and
in a case where printing is performed on the non-permeable medium based on the instruction information, ejecting droplets of a second size smaller than the first size from the nozzles.

11. A non-transitory computer readable storage medium storing a printing program configured to be executed by a computer of a printing device,
the printing device including the computer and an ejection head including nozzles, the nozzles being provided on a nozzle surface the ejection head and being configured to eject droplets,
the printing program comprising instructions that cause, when executed by the computer, the computer to:
acquire instruction information indicating on which one of a permeable medium and a non-permeable medium printing is to be performed, the permeable medium being a printing target, the non-permeable medium being a transfer medium to the printing target;
in a case where printing is performed on the permeable medium based on the instruction information, cause the nozzles to eject droplets of a first size; and
in a case where printing is performed on the non-permeable medium based on the instruction information, cause the nozzles to eject droplets of a second size smaller than the first size.
